(19) United States
(12) Patent Application Publication
(10) Pub. No.: US 2011/0061247 A1
(43) Pub. Date: Mar. 17, 2011

(54) QUICK-RELEASE STRUCTURE FOR OUTER COVER OF A HANDHELD CIRCULAR SAW

(76) Inventor: Chih-Ming CHENG, Taiping City (TW)

(21) Appl. No.: 12/558,864

(22) Filed: Sep. 14, 2009

(51) Int. Cl. B25F 5/02

(52) U.S. Cl. 30/391; 30/286

(57) ABSTRACT

A quick-release structure for outer cover of a handheld circular saw, including a main body, an outer cover, a circular saw blade disposed between the main body and the outer cover, a motor disposed in the main body for driving the circular saw blade and a first, a second, a third and a fourth connection sections. The first and second connection sections are respectively disposed at a first end and a second end of the main body. The third connection section is disposed at a first end of the outer cover corresponding to the first connection section for connecting therewith. The fourth connection section is disposed at a second end of the outer cover corresponding to the second connection section for connecting therewith. The third connection section is angularly and linearly displaceable relative to the outer cover and the first connection section without detaching from the outer cover.

### BACKGROUND OF THE INVENTION

The present invention relates generally to a quick-release structure, and more particularly to a quick-release structure for outer cover of a handheld circular saw.

A conventional handheld circular saw mainly includes a main body, an outer cover, a circular saw blade and a motor. The circular saw blade is disposed between the main body and the outer cover. The motor is disposed in the main body for driving the circular saw blade. The outer cover is assembled and locked with the main body generally by means of one or two threaded rods. When it is necessary to maintain or service the handheld circular saw, the threaded rods are detached with a tool so as to separate the outer cover from the main body. However, in some cases, a suitable tool for detaching the threaded rods can be hardly readily found.

Furthermore, after detached, the threaded rods are separated from the outer cover. In this case, the threaded rods are apt to roll away or be covered by some other articles. Therefore, after the maintenance or service of the handheld circular saw is completed, the threaded rods are often hard to retrieve. Under such circumstance, a user may have to operate the handheld circular saw without the outer cover. This is extremely dangerous to the user.

### SUMMARY OF THE INVENTION

It is therefore a primary object of the present invention to provide a quick-release structure for outer cover of a handheld circular saw, which enables a user to readily and conveniently disassemble and assemble the outer cover of the handheld circular saw.

It is a further object of the present invention to provide the above quick-release structure for outer cover of the handheld circular saw, which can ensure safety in use of the handheld circular saw.

To achieve the above and other objects, the quick-release structure for outer cover of the handheld circular saw of the present invention includes a main body, an outer cover, a circular saw blade disposed between the main body and the outer cover, a motor disposed in the main body for driving the circular saw blade and a first, a second, a third and a fourth connection sections. The first connection section is disposed at a first end of the main body. The second connection section is disposed at a second end of the main body. The third connection section is disposed at a first end of the outer cover corresponding to the first connection section for connecting with the same. The fourth connection section is disposed at a second end of the outer cover corresponding to the second connection section for connecting with the same. The third connection section is angularly and linearly displaceable relative to the outer cover and the first connection section without detaching from the outer cover.

The present invention can be best understood through the following description and accompanying drawings wherein:

### BRIEF DESCRIPTION OF THE DRAWINGS

FIG. 1 is a perspective assembled view of a first embodiment of the present invention;

FIG. 2 is a perspective exploded view of the first embodiment of the present invention, showing the main body, the outer cover, the first connection section, the second connection section, the third connection section and the fourth connection section thereof;

FIG. 3 is a sectional assembled view of the first embodiment of the present invention, showing that the third connection section is assembled with the outer cover corresponding to the first connection section;

FIG. 4 is a perspective exploded view of a second embodiment of the present invention, showing the main body, the outer cover, the first connection section, the second connection section, the third connection section and the fourth connection section thereof; and

FIG. 5 is a sectional assembled view of the second embodiment of the present invention, showing that the third connection section is assembled with the outer cover corresponding to the first connection section.

### DETAILED DESCRIPTION OF THE PREFERRED EMBODIMENTS

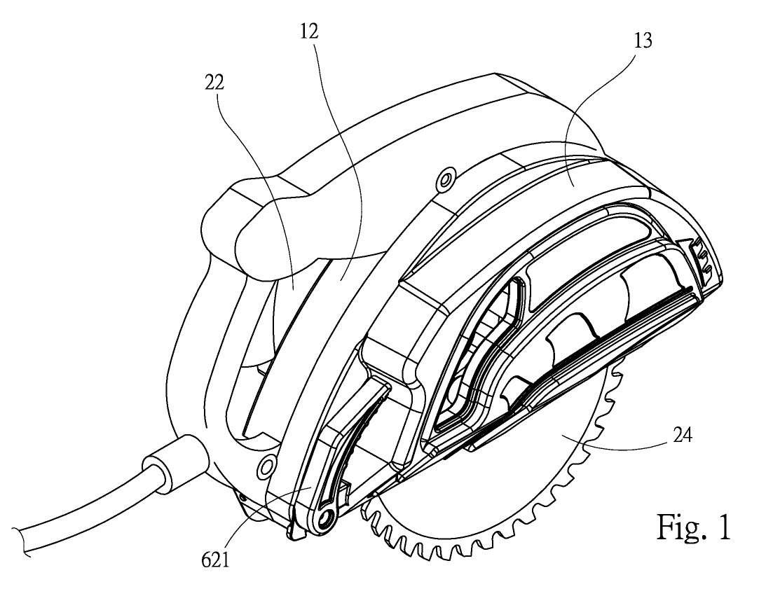

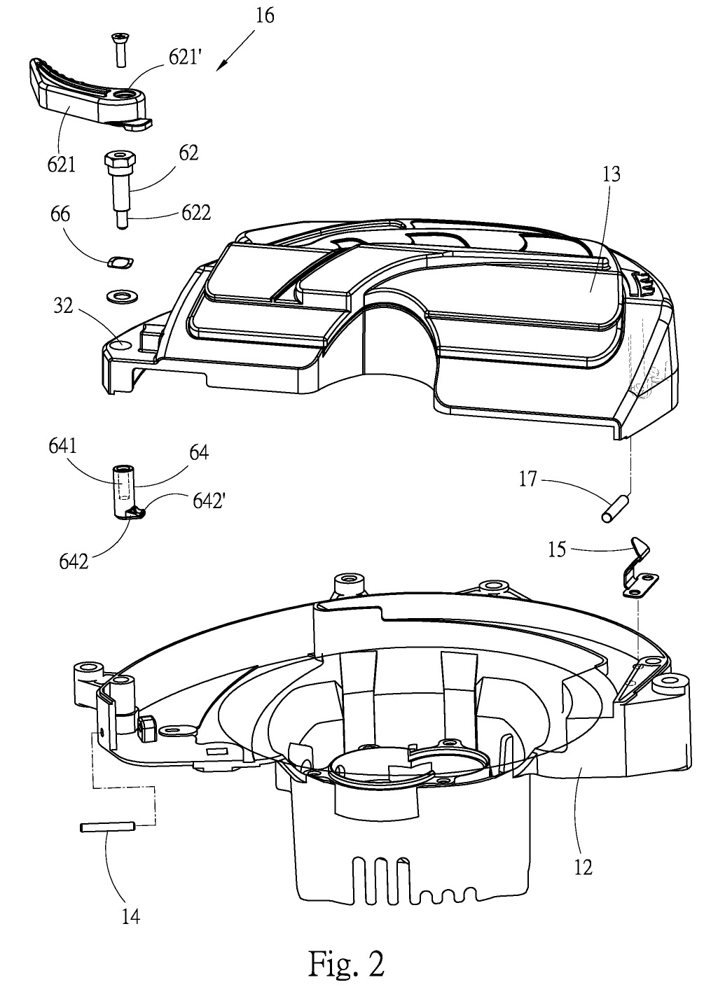

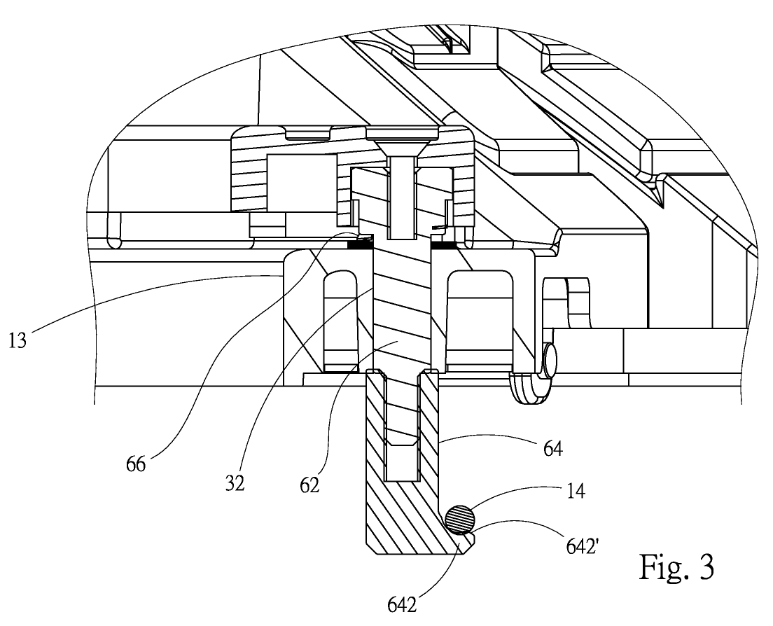

Please refer to FIGS. 1, 2 and 3. According to a first embodiment, the quick-release structure for outer cover of the handheld circular saw of the present invention includes a main body 12, an outer cover 13, a first connection section 14, a second connection section 15, a third connection section 16 and a fourth connection section 17.

A motor 22 is disposed in the main body 12 and connected to a circular saw blade 24 for driving the same. The circular saw blade 24 is disposed between the main body 12 and the outer cover 13.

The first connection section 14 is disposed at a first end of the main body 12. The first connection section 14 can be a column body or a cylindrical body. Two ends of the first connection section 14 are fixedly connected to the main body 12.

The second connection section 15 is disposed at a second end of the main body 12. The second connection section 15 can be a waved plate body. One end of the second connection section 15 is fixedly connected to the main body 12.

The third connection section 16 is disposed at a first end of the outer cover 13 corresponding to the first connection section 14 for connecting with the same.

The third connection section 16 includes a first rod body 62, a second rod body 64 and a resilient member 66.

The first rod body 62 is fitted through a through hole 32 formed on the outer cover 13. A first end of the first rod body 62 is positioned on outer side of the outer cover 13 and has a force application section 621. The outer periphery of the first end of the first rod body 62 is formed with a polygonal shape such as hexagonal shape. The force application section 621 is a shift member. One end of the shift member is formed with a through hole 621′. The inner periphery of the through hole 621′ has a shape corresponding to that of the outer periphery of the first end of the first rod body 621. Accordingly, the shift member can be engaged with or connected with the first rod body 62 by means of a screw. Alternatively, the first end of the first rod body 62 with the hexagonal shape itself serves as the force application section 621. In this case, the first rod body 62 can be wrenched with a tool such as a wrench.

The second rod body 64 is positioned on inner side of the outer cover 13. A first end of the second rod body 64 has a cross-sectional area larger than that of the through hole 32 on the inner side of the outer cover 13. The first end of the second rod body 64 is formed with a threaded hole 641 for connecting with an outer thread 622 of the second end of the first rod body 62. The second end of the second rod body 64 has a hook section 642 outward extending from the second end for hooking the column body or cylindrical body of the first connection section 14. A guide slope 642′ is formed on outer side of the hook section 642.

The resilient member 66 is disposed between the outer cover 13 and the first rod body 62. When the first rod body 62 is rotated and the second rod body 64 is drivingly angularly displaced, the guide slope 642′ of the hook section 642 slides over the column body or cylindrical body of the first connection section 14. Therefore, the second rod body 64 is also driven and vertically displaced. The resilient member 66 can be a wave washer. Two ends of the resilient member 66 respectively abut against the outer cover 13 and the first rod body 62.

The fourth connection section 17 is disposed at a second end of the outer cover 13 corresponding to the second connection section 15 for connecting with the same.

The fourth connection section 17 can be a column body or cylindrical body fixedly disposed on the outer cover 13 for engaging with the waved plate body of the second connection section 15. Alternatively, the second connection section 15 can be a C-shaped plate body (not shown). In this case, the column body or cylindrical body can be also engaged with the C-shaped plate body.

According to the above arrangement, after using the circular saw and when it is necessary to detach the outer cover 13 for maintaining or servicing the circular saw, a user only needs to rotate the first rod body 62 to separate the first and second connection sections 14, 16 from each other. Then the second and fourth connection sections 15, 17 are separated from each other. After serviced, a user can perform an operation reverse to the above operation to easily assemble the outer cover 13 with the main body 12.

After the outer cover 13 is disassembled, the assembling components will not detach from the outer cover 13 so that the user can immediately reassemble the outer cover 13 with the main body 12. Accordingly, the problem existing in the prior art that the assembling components are often hard to find is eliminated. Therefore, the user is protected from holding the circular saw without the outer cover so that the safety can be ensured.

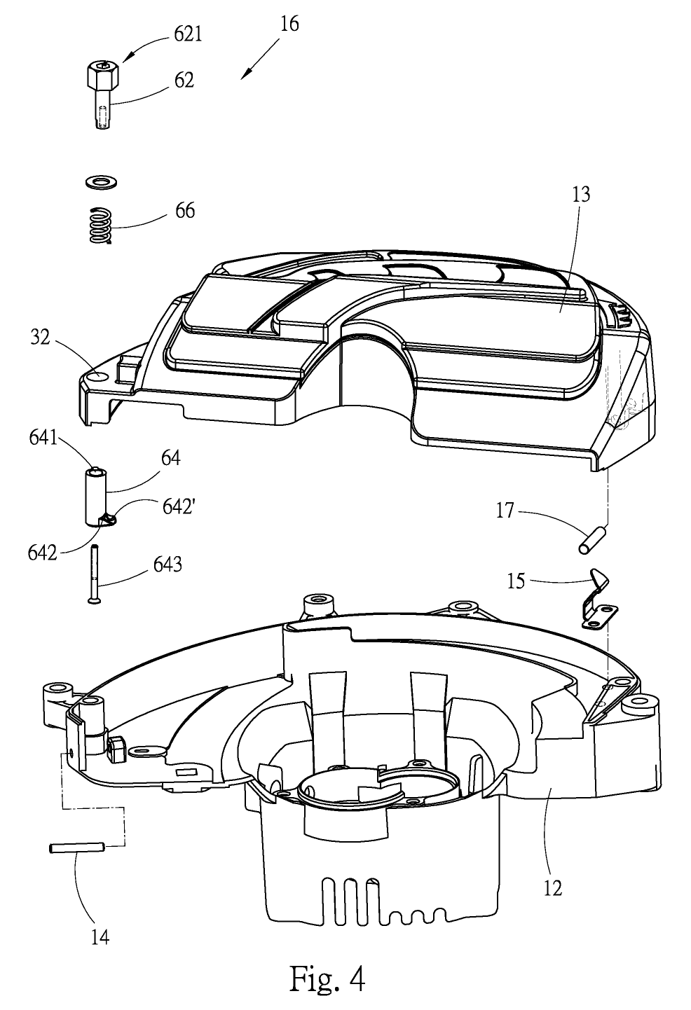

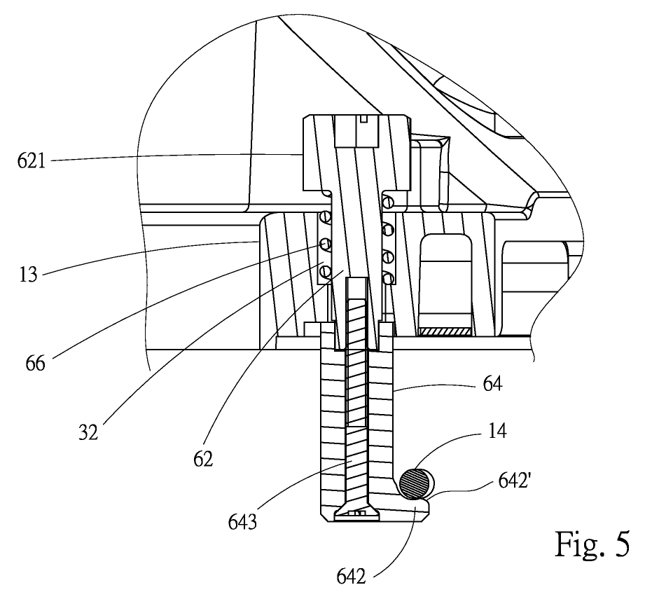

Please refer to FIGS. 4 and 5, which show a second embodiment of the quick-release structure for outer cover of the handheld circular saw of the present invention. In this embodiment, the through hole 32 of the outer cover 13 is stepped hole and the resilient member 66 is a coiled spring.

The coiled spring is positioned in the through hole 32 of the outer cover 13. The first rod body 62 is fitted through the coiled spring.

The hole 641 of the second rod body 64 extends through the second rod body 64. The first rod body 62 is formed with a threaded hole 623. A screw 643 is screwed through the hole 641 into the threaded hole 623 of the first rod body 62 to connect the first and second rod bodies 62, 64.

The above embodiments are only used to illustrate the present invention, not intended to limit the scope thereof. Many modifications of the above embodiments can be made without departing from the spirit of the present invention.

What is claimed is:

1. A quick-release structure for outer cover of a handheld circular saw, comprising a main body, an outer cover, a circular saw blade, a motor, a first connection section, a second connection section, a third connection section and a fourth connection section, wherein:
the circular saw blade is disposed between the main body and the outer cover; the motor is disposed in the main body for driving the circular saw blade; the first connection section is disposed at a first end of the main body;
the second connection section is disposed at a second end of the main body;
the third connection section is disposed at a first end of the outer cover corresponding to the first connection section for connecting with the first connection section; and
the fourth connection section is disposed at a second end of the outer cover corresponding to the second connection section for connecting with the second connection section, the quick-release structure being characterized in that the third connection section is angularly and linearly displaceable relative to the outer cover and the first connection section without detaching from the outer cover, whereby the first connection section and the third connection section are selected from the group consisting of engaging and disengaging.

2. The quick-release structure for outer cover of the handheld circular saw as claimed in claim 1, wherein the first connection section is a column body fixedly disposed on the main body, the third connection section including a first rod body, a second rod body and a resilient member, the first rod body being fitted through a through hole formed on the outer cover, a first end of the first rod body being positioned on outer side of the outer cover and having a force application section, the second rod body being positioned on inner side of the outer cover, a first end of the second rod body having a cross-sectional area larger than that of the through hole on the inner side of the outer cover, the first end of the second rod body being connected with a second end of the first rod body, a second end of the second rod body having a hook section outward extending from the second end for hooking the column body, a guide slope being formed on outer side of the hook section, the resilient member being disposed between the outer cover and the first rod body, whereby when the first rod body is rotated and the second rod body is drivingly angularly displaced, the second rod body is also driven and vertically displaced.

3. The quick-release structure for outer cover of the handheld circular saw as claimed in claim 2, wherein the resilient member is a wave washer and positioned between outer side of the outer cover and the first rod body.

4. The quick-release structure for outer cover of the handheld circular saw as claimed in claim 2, wherein outer periphery of the first end of the first rod body is formed with a polygonal shape and the force application section is a shift member, one end of the shift member being formed with a through hole, inner periphery of the through hole having a shape corresponding to that of the outer periphery of the first end of the first rod body for connecting with the first rod body.

5. The quick-release structure for outer cover of the handheld circular saw as claimed in claim 2, wherein the resilient member is a coiled spring.

6. The quick-release structure for outer cover of the handheld circular saw as claimed in claim 2, wherein the second connection section is a waved plate body fixedly disposed on the main body, the fourth connection section being a column body fixedly disposed on the outer cover for engaging with the waved plate body.

7. The quick-release structure for outer cover of the handheld circular saw as claimed in claim 3, wherein the second connection section is a waved plate body fixedly disposed on the main body, the fourth connection section being a column body fixedly disposed on the outer cover for engaging with the waved plate body.

8. The quick-release structure for outer cover of the handheld circular saw as claimed in claim 4, wherein the second connection section is a waved plate body fixedly disposed on the main body, the fourth connection section being a column body fixedly disposed on the outer cover for engaging with the waved plate body.

9. The quick-release structure for outer cover of the handheld circular saw as claimed in claim 5, wherein the second connection section is a waved plate body fixedly disposed on the main body, the fourth connection section being a column body fixedly disposed on the outer cover for engaging with the waved plate body.
